(19) United States
(12) Patent Application Publication
(10) Pub. No.: US 2022/0279757 A1
(43) Pub. Date: Sep. 8, 2022

(54) WEARABLE PROTECTION SYSTEMS FOR AN ANIMAL AND METHODS FOR USING THE SAME

(71) Applicant: Phoenix Lorelei Avery, Seattle, WA (US)

(72) Inventor: Phoenix Lorelei Avery, Seattle, WA (US)

(21) Appl. No.: 17/192,726

(22) Filed: Mar. 4, 2021

(51) Int. Cl. A01K 13/00

(52) U.S. Cl. CPC A01K 13/007

(57) ABSTRACT

A system for protecting an animal, and associated methods are disclosed herein. In some embodiments, the system includes a front leg element that wraps over the animal's shoulders. The front leg element can have first and second distal portions that each include a pouch positioned to receive one of the animal's front feet. The system can further include a rear leg element that wraps over the animal's back. The rear leg element can have first and second distal portions that each include a pouch positioned to receive one of the animal's rear feet. A connecting element has a forward portion attached to the foreleg element and a rear portion the rear leg element.

### TECHNICAL FIELD

The present technology is directed to protective systems animal, and more specifically to self-retaining protective wear worn on an animal's feet.

### BACKGROUND

Domestic animals often require medical attention multiple times in their lives to address accident-related injuries and internal health problems that require surgery. This medical attention can leave the animal with a wound that needs to heal over a period of a week or more. While many advancements have been made in initially treating and dressing the wound, fewer advancements have been made to help keep the wound clean and protected while it heals. Foot and leg wounds are particularly challenging because they interfere with the animal's mobility. Accordingly, the animals and their owners are in need of systems to protect the animal's paws during the recovery period.

Current systems for protecting an animal's feet include forcing the animal to wear a head cone to prevent the animal from licking and/or chewing on its wounds. Other systems include strap-based covers that provide a protective shield over the wound. However, the head cones are uncomfortable for the animals to wear full time and offer no other protection during day-to-day activities, while the strap-based covers are too easy for the animal to remove and often fall off when the animal is in motion. Some systems have linked movement between covers for the front paws, but leave the rear paws exposed. Accordingly, further and better solutions are needed.

### BRIEF DESCRIPTION OF THE DRAWINGS

FIG. 1 is an isometric front view of a system for protecting an animal's paws in accordance with representative embodiments of the present technology.

FIG. 2 is an isometric front view of the system of FIG. 1 deployed on a dog to in accordance with representative embodiments of the present technology.

FIG. 3 is an isometric left side view of the system of FIG. 1 deployed on a dog in accordance with representative embodiments of the present technology.

FIG. 4 is an isometric right side view of the system of FIG. 1 deployed in conjunction with a harness in accordance with representative embodiments of the present technology.

FIG. 5 is an illustrative view of the system of the type illustrated in FIG. 4 in accordance with representative embodiments of the present technology.

The drawings have not necessarily been drawn to scale. In the Figures, similar reference numbers identify identical or at least generally similar elements.

### DETAILED DESCRIPTION

### Overview

Wearable protection systems for an animal's feet and associated methods are disclosed herein. A representative system includes a front leg element, a rear leg element, and a connecting element that are interconnected to provide protection for the animal's feet. The front leg element can include a single unit that further includes a shoulder portion (e.g., a shoulder strap or shoulder section) that wraps over an animal's shoulders to position distal ends of the front leg element near the animal's paws. The distal ends include portions that can have pouches (e.g., openings in the material, pockets, compartments, and/or chambers) that can receive, and provide a protective layer over, the animal's front feet. Similarly, the rear leg element can be a single unit that includes a back portion that wraps over the animal's back and position two distal ends near the animal's rear paws. The distal ends can include portions that have pouches positioned to receive the animal's rear feet. The connecting element is attached to and extends between the front leg element and the rear leg element. In various embodiments, the connecting element can be releasably attached, fixedly attached, and/or adjustably attached to either, or both of, the front leg element and the rear leg element.

Interconnecting the elements allows the system to remain in place without the need for extra straps, collars, and/or connectors by transmitting (e.g., commuting, offsetting, partially offsetting, translating, and/or disseminating) forces throughout the system. The loads can come from the weight of the animal's paws and/or the system itself, from the animal pulling on an element, and/or from external sources (e.g., from the animal catching the system on something). For example, when one of the distal ends of the front or rear leg element is pulled outwards (e.g., away from the animal), the other distal end of that element is pulled inwards (e.g., toward the animal). Furthermore, a force pulling on the shoulder and/or back portion will necessarily need to pull on the two corresponding sets of distal ends. Accordingly, once an animal's paws are placed inside the pouches, it can be hard for the animal to remove the front and/or rear leg element—intentionally or unintentionally.

Further, the connecting element transmits forces between the shoulder portion of the front leg element and the back portion of the rear leg element. For example, a force pulling backwards on the back portion of the rear leg element will also at least partly pull backwards on the shoulder portion of the front leg element, thereby also pulling upwards on the two front distal ends. Conversely, for example, an outward force on a distal end of the front leg element will at least partly pull inwards on the distal ends of the rear leg element. By transmitting forces between the front leg element, the rear leg element, and their respective distal ends, the system can further resist being removed by the animal. The system can also resist sliding off when the animal is in motion and/or when the system gets caught on something, and can therefore remain generally in position to protect the animal's feet.

In some embodiments, the present technology includes a method for positioning an article on a dog to protect the dog's paws. For example, one such method includes positioning the dog's front paws in a front leg element having a front left pouch, a front right pouch, and a shoulder element. Positioning the front leg element can include positioning the dog's front left paw in the front left pouch, positioning the dog's front right paw in the front right pouch, and wrapping the shoulder element over the dog's shoulders. In some embodiments, the front leg element can be positioned to transmit a first force tending to pull the front left pouch away from the front left paw to pull the front right pouch toward the front right paw. In some embodiments, the method can include positioning the dog's rear paws in a rear leg element having a rear left pouch, a rear right pouch, and a back element. Positioning the rear leg element can include positioning the dog's rear left paw in the rear left pouch, positioning the dog's rear right paw in the rear right pouch, and wrapping the back element over the dog's back. In some embodiments, the rear leg element can be positioned to transmit a second force tending to pull the rear left pouch away from the rear left paw to pull the rear right pouch toward the rear right paw. In some embodiments, the method can include positioning a connecting element, which extends between the front leg element and the rear leg element. In some embodiments, the connecting element can be positioned to transmit a third force tending to pull the rear leg element backwards to pull the front leg element backwards.

Although discussed and illustrated herein primarily in the context of a system for protecting a dog's paws, one of skill in the art will understand that the scope of the invention is not so limited. Rather, the devices in accordance with the present technology can be appropriately sized to protect the feet of most animals. For example, the system may also be sized to protect a cat's paws, a rabbit's feet, and/or a horse's hooves. Accordingly, the scope of the present technology is not confined to any particular subset of embodiments except as defined by the claims.

### DESCRIPTION OF FIGURES

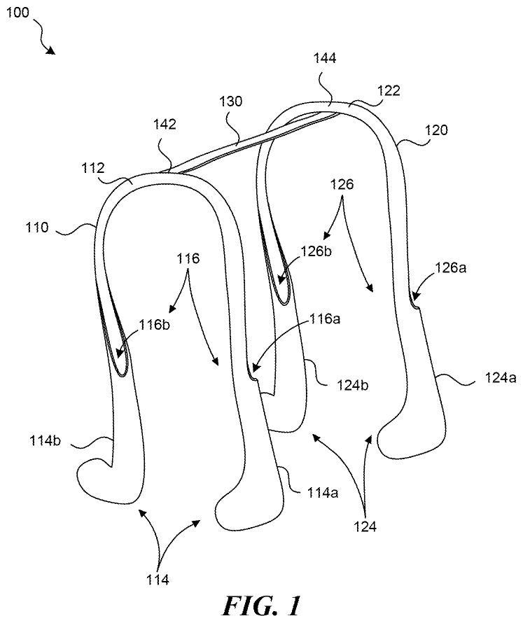

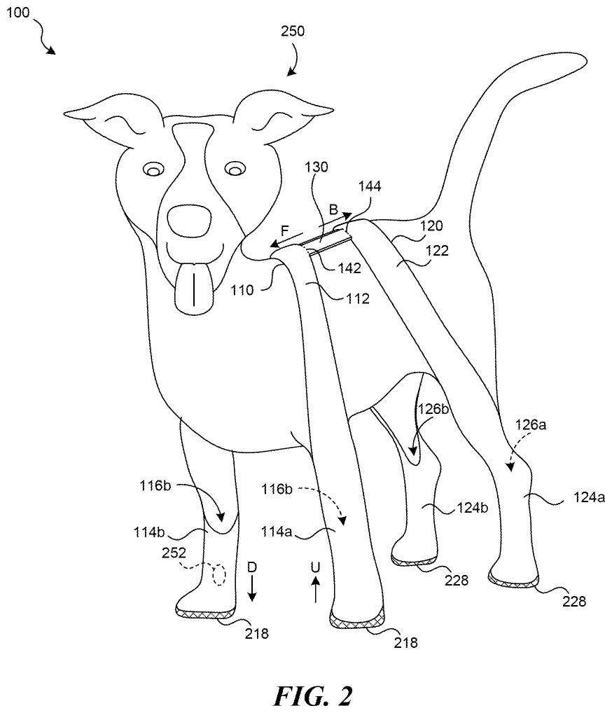

FIG. 1 is an isometric front view of the system 100 configured in accordance with embodiments of the present technology. As illustrated in FIG. 1, the system 100 includes a representative front leg element 110, a rear leg element 120, and a connecting element 130. The front leg element 110 includes a shoulder strap 112 (e.g., a shoulder portion), distal ends 114, shown as a left distal end 114a and a right distal end 114b, and corresponding pouches 116, shown as a left pouch 116a and a right pouch 116b at the corresponding distal ends 114a, 114b. Similarly, the rear leg element 120 includes a back strap 122 (e.g., a back portion), distal ends 124, shown as a left distal end 124 a and a right distal end 124b, and corresponding pouches 126, shown as a left pouch 126a and a right pouch 126b at corresponding distal ends 124a, 124b. The pouches 116 of the front leg element 110 can be shaped to receive an animal's front paws (as described later with reference to FIG. 2), while the pouches 126 of the rear leg element 120 can be shaped to receive the animal's rear paws.

As further illustrated in FIG. 1, the front leg element 110 is connected to the connecting element 130 at a front connecting joint 142, while the rear leg element 120 is connected to the connecting element 130 at a rear connecting joint 144. In some embodiments, the connecting element 130 can be fixedly attached to the front leg element 110 by a permanent, or nearly permanent, front connecting joint 142, for example via stitching, fabric glue, and/or another suitable fastening technique, or by constructing the front leg element 110 and the connecting element 130 from a single piece of material. In some embodiments, the connecting element 130 can be removably attached to the front leg element 110 by a removable front connecting joint 142 (e.g., Velcro®, an eye bolt snap, other snaps, buttons, buckles, other suitable releasable fasteners, and/or an open loop in the connecting element 130). For example, in some embodiments, the connecting joint 142 can be a sleeve of material on the connecting element 130 that is open at either end. To attach the connecting element 130 and the front leg element 110, a user can pull the front leg element 110 through the sleeve. Similarly, in some embodiments, the connecting element 130 can be either fixedly attached or removably attached to the rear leg element 120 at a corresponding rear connecting joint 144.

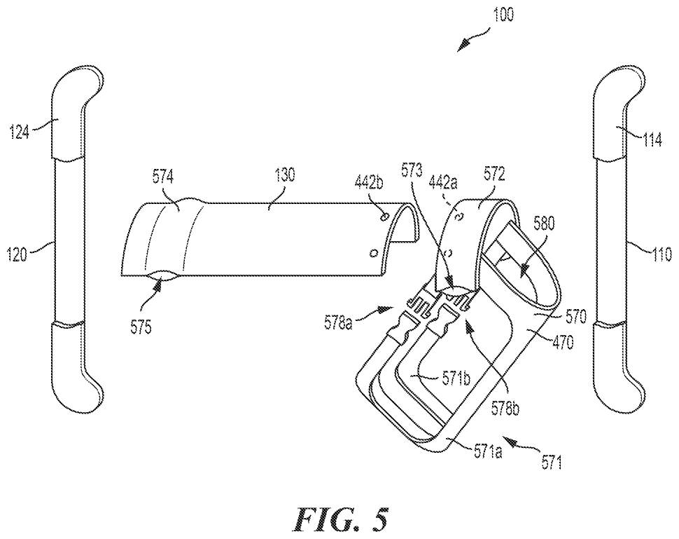

In some embodiments, the front leg element 110, the rear leg element 120 and connecting element 130 can all be made from a flexible and/or stretchable material (e.g., jersey knit, cotton, wool, velvet, fleece, or another suitable stretchable material) allowing a user to easily position the system in place (as described later with reference to FIG. 2). In various embodiments, the material can be selected based on insulative properties, water-resistant properties, flexibility, stretchability, compatibility with the animal's sense of touch, antibacterial properties, traction, aesthetic appeal, and/or any combination thereof. In some embodiments, the front leg element 110, rear leg element 120 and connecting element 130 can include a multilayered material with layers selected based on the considerations disclosed above. For example, the material may include an antibacterial inner layer, a water-resistant intermediate layer, and an aesthetic outer layer. In some embodiments, any one or more of the front leg element 110, the rear leg element 120, or the connecting element 130 can include a different material than the others. For example, the front leg element 110 and the rear leg element 120 can include a textile material while the connecting element 130 can be a rope (e.g., made of nylon, polyester, polypropylene, and/or other suitable fibers) and/or an inelastic material. In some embodiments, each of the front leg element 110, the rear leg element 120, and the connecting element 130 can be made from a different material. Further, although each of the front leg element 110, the rear leg element 120, and the connecting element 130 are illustrated as thin strips of material, the connecting element 130 can be sized to cover a larger portion of the animal's back. In some embodiments, for example, the connecting element 130 can be sized to act as a coat for the animal, and therefore wrap at least partially around the sides of the animal's back (see, e.g., FIG. 5).

FIG. 2 is an isometric front view of the system 100 of FIG. 1 deployed on a small dog 250 in accordance with representative embodiments of the present technology. In the illustrated embodiment, the dog's left and right front paws have been inserted into the corresponding left and right pouches 116a, 116b (FIG. 1) at the corresponding distal ends 114a, 114b of the front leg element 110, while the dog's left and right rear paws have been inserted into the corresponding left and right pouches 126a, 126b at the corresponding left and right distal ends 124a, 124b of the rear leg element 120. The distal ends 114 of the front leg element 110 are connected to the shoulder strap 112, and the shoulder strap 112 wraps around a shoulder portion of the dog 250. Similarly, the distal ends 124 of the rear leg element 120 are connected to the back strap 122, and the back strap 122 wraps around a back portion of the dog 250. As illustrated, the front leg element 110 can provide a protective layer over the dog's wound 252 (e.g., here, provided by the front leg element when the dog's front right paw is inserted into the front right pouch 116a). The protection provided by the front leg element 110 can reduce the dog's ability to lick, dirty, and/or otherwise contaminate the wound 252.

As further illustrated in FIG. 2, because the features of the front leg element 110 are interconnected and the front leg element 110 is positioned over the dog's shoulders, the front leg element 110 can transmit forces through the shoulder strap 112. For example, a downward force, indicated by arrow D, on the right distal end 114b is transmitted through the shoulder strap 112 to the left distal end 114a resulting in an upward force, indicated by arrow U, on the left distal end 114a. That is, a force pulling downwards on the right distal end 114b will subsequently pull upwards on the left distal end 114a. As a result, it can be hard for the dog 250 to remove the front leg element 110 on its own (e.g., by pulling on either end with its mouth, moving around, and/or catching the front leg element 110 on something). Similarly, the rear leg element 120 also transmits forces over the dog's back and through the back strap 122. For example, a downward force pulling on the left distal end 124a of the rear leg element 120 will subsequently pull upwards on the right distal end 124b.

Further, because the connecting element 130 connects the front leg element 110 and the rear leg element 120, the connecting element 130 can also transmit forces between elements in the system 100. For example, a backward force, indicated by arrow B, pulling on the rear leg element 120 will be at least partly transmitted through the connecting element 130 to the shoulder strap 112 to pull backwards on the shoulder strap 112. The backward force pulling on the shoulder strap 112 will then be transmitted to pull upwards on the distal ends 114 of the front leg element 110. Similarly, a forward force, indicated by arrow F, pulling on the front leg element 110 will be transmitted through the connecting element 130 to pull forwards on the back strap 122, thereby pulling upwards on the distal ends 124 of the rear leg element 120. By linking the lateral forces between the front leg element 110 and the rear leg element 120, the connecting element 130 can effectively hold the system 100 in place on the dog 250. For example, the rear leg element 120 cannot slide off of the backside of the dog without subsequently pulling the connecting element 130 (and therefore the front leg element 110) backwards. Accordingly, the system 100 can remain in place without the need for any additional straps, buckles, and/or other restraining devices.

As further illustrated in FIG. 2, the front leg element 110 can also include an additional protective layer 218 disposed on the distalmost surface of the distal ends 114 (e.g., under the dog's paws). In some embodiments, the protective layer 218 can be a waterproof material that at least partially restricts moisture from entering the interior of the front pouches 116 thereby at least partially protecting the dog's paws. In some embodiments, the protective layer 218 includes a shock absorbing material that can at least partially dissipate impact forces on the dog's front paws. Similarly, in the illustrated embodiment, the rear leg element 120 also includes a protective layer 228 disposed on the distalmost portion of the distal ends 124. In various embodiments, the protective layer 228 can also include a waterproof material and/or a shock absorbing material configured to at least partially protect the dog's rear paws. In some embodiments, for example, the protective layer can include a flexible rubber (e.g., neoprene), canvas, Cut-Tex® PRO, Kevlar, flexible thermal material (e.g., Insul-Bright® Insulated Lining), or any other suitable material. Further, it will be understood that the materials included in the protective layer 228, along with the density and overage of the protective layer 228, can vary based on a predetermined protection level. In turn, the predetermined protection level can be based at least partially on an environment in which the system 100 is deployed (e.g., whether the system 100 is deployed for protection off-pavement, on hot and/or cold pavement, only indoors, or in any other suitable environment).

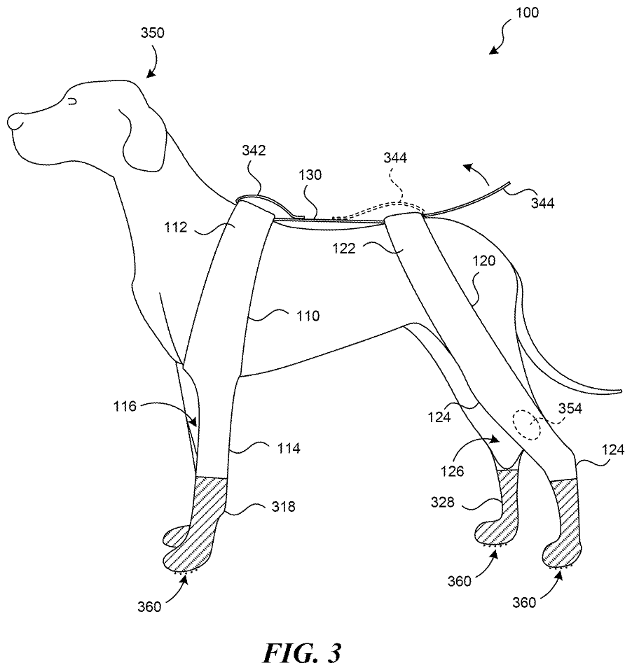

FIG. 3 is an isometric left side view of a representative system 100 deployed on a larger dog 350. As illustrated, the system 100 is generally similar in structure and function to the system described above with respect to FIGS. 1 and 2. For example, the system 100 includes a front leg element 110, a rear leg element 120, and a connecting element 130. The elements 110, 120, 130 are interconnected so that the system 100 remains in place to protect the dog's paws, and the system 100 can provide at least one protective layer to the dog's paws and/or wounds. For example, the rear leg element 120 can provide a protective layer over a wound 354 on the rear leg of the dog 353. Because the elements 110, 120, 130 are interconnected, the rear leg element 120 remains in position to reduce the dog's ability to lick, dirty, and/or otherwise contaminate the wound 352.

As illustrated in FIG. 3, the front leg element 110 can further include a protective layer 318 disposed on a larger portion of the distal ends 114 than in the embodiment shown in FIG. 2. For example, the protective layer 318 may be disposed on and cover an outside surface of the pouches 116 upwardly from the dog's paws. Similarly, the rear leg element 120 includes a protective layer 328 that disposed on a larger portion of the distal ends 124 of the rear leg element 120, for example covering an upwardly extending outside surface of the pouches 126. This relatively large covering may be advantageous to provide further water protection for the dog's paws. Further, the protective layers 318, 328 can include traction elements 360 (e.g., nubs or other projections) positioned to be underneath the dog's paws when the system 100 is deployed on the dog 350.

As is further illustrated in FIG. 3, the connecting element 130 can include a front attachment element 342 and a rear attachment element 344. The front and rear attachment elements 342, 344 loop around the front leg element 110 and rear leg element 120, respectively, and are secured to the connecting element 130. For example, the front attachment element 342 can loop around the shoulder strap 112 and be secured to the connecting element 130 via hook-and-loop fasteners (e.g., Velcro®), a buckle fastener, buttons, snaps, an/or other suitable fasteners. Similarly, the rear attachment element 344 can wrap around the back strap 122 of the rear leg element 120 and be secured to the connecting element 130 via hook-and-loop fasteners (e.g., Velcro®), a buckle fastener, buttons, snaps, and/or other suitable fasteners. Depending on the size of the dog 350, the front and rear attachment elements 342, 344 can be adjustably attached by pulling more or less of the connecting element 130 through the loop before attaching securing the front and rear attachment joints 342, 344.

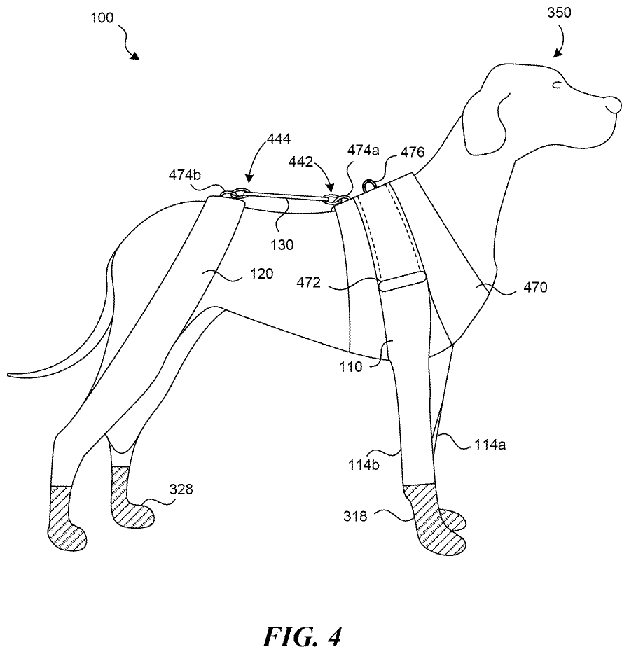

FIG. 4 is an isometric right side view of a representative system 100 deployed in conjunction with a harness 470 in accordance with some embodiments of the present technology. The harness 470 is positioned to wrap circumferentially around the upper body of the dog 350 and can be generally similar to those commercially available, but with additional features to make it compatible with the system 100. For example, the harness 470 can include joining elements 472 positioned proximate to the left and right shoulders of the dog 350. The joining elements 472 mate with the front leg element 110 in order to link forces at either of the distal ends 114 to the harness 470. For example, a downward force on the left distal end 114a would be transmitted to pull downwards on the harness 470.

In the illustrated embodiment, the joining elements 472 are buckle loops secured on the upper end to the harness 470, while the lower end is free to mate with the front leg element 110. To secure the front leg element 110 to the harness 470, a user can pull one distal end 114 of the front leg element 110 through the open portion of one of the joining elements 472, then pull the other distal end 114 through the other joining element 472. In some embodiments, when the front leg element 110 is mated with the harness 470, the shoulder strap 112 can wrap under the dog's stomach rather than over the dog's shoulders. In other embodiments, the shoulder strap can still wrap over the dog's shoulders. For example, in some embodiments, the joining elements 472 can be an opening for a cloth sleeve extending over the dog's shoulders (see, e.g., FIG. 5), through which the front leg element 110 can be pulled. In still other embodiments (not shown), various other suitable devices can be used to join the front leg element 110 to the harness 470 in order to link forces between the two. For example, in some embodiments, the joining elements 472 can be cloth hooks through which the front leg element 110 can be pulled.

FIG. 4 also illustrates another attachment between the front leg element 110, the rear leg element 120, and the connecting element 130. In the illustrated embodiment, the harness 470 can include a front attachment element 474a that can mate with the connecting element 130 through a front connecting element 442. By attaching to the harness 470, the connecting element 130 can be effectively linked to the front leg element 110. As illustrated, the front attachment element 474a is a loop, and the front connecting element 442 includes a clipping element (e.g., a carabiner, an eye bolt snap, and/or other suitable clipping devices) designed to latch onto the front attachment element 474a. Similarly, the rear leg element 120 also includes a rear attachment element 474b that mates with a rear connecting element 444 to connect the rear leg element 120 to the connecting element 130. As illustrated, the rear attachment element 474b can also be a loop, and the rear connecting element 444 can be a clipping element designed to latch onto the rear attachment element 474b.

In various embodiments, the harness 470 can also include numerous other features to add to the convenience of using the system 100. For example, in the illustrated embodiment, the harness also includes a loop 476 onto which a leash may be attached to walk the dog 350. In some embodiments, the harness 470 can include pockets (not shown) to store medical supplies for the dog 350 in case the dog's wound opens while on a walk. In some embodiments, the harness 470 can include hooks (e.g., D-hooks, not shown) that allow various accessories (e.g., a waste bag container, bells, food containers, or any other suitable accessory) to attach to the harness 470.

FIG. 5 is an exploded view of a representative system 100 of the type illustrated in FIG. 4, configured in accordance with representative embodiments of the present technology. As illustrated, the system 100 includes the front leg element 110, the harness 470, the rear leg element 120 and the connecting element 130, each of which is a removable element of the system 100. The harness 470 includes a main body 570 and two straps 571 (referred to individually as a first strap 571a and a second strap 571b). The main body 570 includes head hole 580 positioned to receive an animal's head and neck. The straps 571 are positioned to wrap around the animal's front legs and reconnect to the main body 570 to secure the harness 470 in place. In the illustrated embodiment, the first strap 571a can reconnect to the main body 570 through a first connecting element 578a (e.g., side release buckle (as illustrated), a cam buckle, ratchet, snaps, belt buckle, and/or any other suitable element). Similarly, the second strap 571b can reconnect to the main body 570 through a second connecting element 578b. In some embodiments, the first and second connecting elements 578a, 578b are of the same type. In other embodiments, the first and second connecting elements 578a, 578b are different types of connecting mechanisms.

As further illustrated in FIG. 5, the harness 470 includes a sleeve 572 positioned to wrap over the animal's shoulders when the harness 470 is in place. The sleeve 572 includes an opening 573 at each end that is sized to receive the front leg element 110. The user can connect the front leg element 110 to the harness 470 by pulling either end of the front leg element 110 through the sleeve 572. Accordingly, the harness 470 can be placed on the animal before attaching the front leg element 110. As a result, the process of attaching the harness 470 can be simplified (e.g., because the user does not have to manage the front leg element 110 in addition to the harness 470).

As further illustrated in FIG. 5, the harness 470 includes a front connecting element 442a positioned to connect to a corresponding front connecting element 442b on the connecting element 130. In various embodiments, the front connecting elements 442a, 442b can be corresponding snaps (as illustrated), Velcro® pads or other hook-and-loop fasteners, corresponding sides of a zipper, and/or various other suitable fasteners. In some embodiments, the connecting element 130 can be permanently attached to the harness 470 (e.g., formed as an integral part of the harness 470, stitched to the harness, and/or through any other suitable permanent connection).

In the illustrated embodiment, the connecting element 130 extends down an animal's back while at least partially wrapping over the animal's back, thereby acting as a partial coat. As further illustrated in FIG. 5, the connecting element 130 includes a sleeve 574 positioned to hold the rear leg element 120 in place. The sleeve 574 includes an opening 575 on each end that is sized to receive the rear leg element 120. The user can connect the rear leg element 120 to the connecting element 130 by pulling either end of the rear leg element 120 through the sleeve 574. Accordingly, the connecting element 130 can be attached to the harness before attaching the rear leg element 120.

As a result of each of the connections described above, to attach the system 100, the user can place the main body 570 of the harness 470 in place on the animal's shoulders and connect the straps 571 to the main body 570. Next, the user can pull the front leg element 110 through the sleeve 572 and place the animal's front paws in corresponding distal ends 114 (e.g., FIG. 2) of the front leg element 110. The user can then attach the connecting element 130 to the harness using the front connecting elements 442a, 442b. Next, the user can pull the rear leg element 120 through the sleeve 574 and place the animal's rear paws in corresponding distal ends 124 (e.g., FIG. 2) of the rear leg element 120. In some embodiments, the user can perform these steps in a different order. For example, the user can attach the harness 470 to the animal, attach the connecting element 130, attach the rear leg element 120, then attach the front leg element 110.

From the foregoing, it will be appreciated that specific embodiments of the technology have been described herein for purposes of illustration, but that well-known structures and functions have not been shown or described in detail to avoid unnecessarily obscuring the description of the embodiments of the technology. In addition, some components and/or operations can be separated into different elements or combined into a single element for the purpose of discussion of some of the embodiments of the present technology. Moreover, while the technology is amenable to various modifications and alternative forms, specific embodiments have been shown by way of example in the drawings and the foregoing description. The intention, however, is not to limit the technology to the particular embodiments described. Furthermore, although advantages associated with certain embodiments of the technology have been described in the context of those embodiments, other embodiments may also exhibit such advantages, and not all embodiments need necessarily exhibit such advantages to fall within the scope of the technology. For example, several embodiments of the present technology have been described in the context of protecting an animal's paws. In addition to, or in lieu of, protecting the paws, systems in accordance with the present technology can protect other areas of the animal (e.g., a wound on the animal's leg), as shown in FIG. 3. In further embodiments, other elements can also protect other parts of an animal. For example, the front leg element can protect the animal's shoulders, the rear leg element can protect the animal's hindquarters, and/or the connecting element can protect the animal's back and/or torso area. Accordingly, the disclosure and associated technology can encompass other embodiments not expressly shown or described herein.

To the extent any material incorporated herein by reference conflicts with the present disclosure, the present disclosure controls. Where the context permits, singular or plural terms may also include the plural or singular term, respectively. Used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded.

I/We claim:

1. A system for protecting an animal, the system comprising:
a front leg section including:
a front-left pouch configured to receive the animal's front-left paw;
a front-right pouch configured to receive the animal's front-right paw; and
a shoulder strap connected to the front-left pouch and the front-right pouch, the shoulder strap configured to wrap over the animal's shoulders such that pulling the front-right pouch away from the animal's shoulders pulls the front-left pouch toward the animal's shoulders;
a rear leg section including:
a rear-left pouch configured to receive the animal's rear-left paw;
a rear-right pouch configured to receive the animal's rear-right paw; and
a rear strap connected to the rear-left pouch and the rear-right pouch, the rear strap configured to wrap over the animal's back such that pulling the rear-right pouch away from the animal's back pulls the rear-left pouch toward the animal's back; and
a connecting element attached to the front shoulder strap and the rear strap.

2. The system of claim 1 wherein the connection element is configured to transmit forces such that pulling the rear leg section generally away from the animal's head also pulls the front leg section generally away from the animal's head.

3. The system of claim 1, further comprising a protective layer disposed on an outside surface of each of the front-left pouch, the front-right pouch, the rear-left pouch, and the rear-right pouch.

4. The system of claim 3 wherein the protective layer includes a waterproof material positioned to at least restrict moisture from entering an interior of each of the front-left pouch, the front-right pouch, the rear-left pouch, and the rear-right pouch.

5. The system of claim 3 wherein the protective layer includes a shock absorbing material positioned to dissipate impact forces.

6. The system of claim 1 wherein a first end of the connecting element is fixedly attached to the front shoulder strap.

7. The system of claim 1 wherein a first end of the connecting element is releasably attached to the front shoulder strap.

8. The system of claim 1 wherein a second end of the connecting element is fixedly attached to the rear strap.

9. The system of claim 1, further comprising a harness positioned to wrap circumferentially around an upper body of the animal, wherein the harness is connected to the foreleg section to thereby retain the foreleg section in place and wherein the harness at least partially anchors the rear leg section via the connecting element.

10. A system for protecting an animal's front and rear feet, the system comprising:
a front leg element positioned to wrap over the animal's shoulders and having first and second distal portions, wherein each of the distal portions of the front leg element includes a pocket positioned to receive one of the animal's front feet;
a rear leg element positioned to wrap over the animal's back and having first and second distal portions, wherein each of the distal portions of the rear leg element includes a pocket positioned to receive one of the animal's rear feet; and
a connecting element having a forward portion attached to the front leg element and a rear portion the rear leg element.

11. The system of claim 10 wherein the rear portion of the connecting element is fixedly attached to the rear leg element.

12. The system of claim 10 wherein the forward portion of the connecting element is releasably attached to the foreleg element.

13. The system of claim 10 where the forward portion of the connecting element is adjustably attached to the foreleg element.

14. The system of claim 10, further comprising a protective material disposed on an outside surface of each of the distal ends of the foreleg element and each of the distal ends of the rear leg element.

15. The system of claim 10 where the connecting element includes an inelastic material positioned to link lateral movement between the foreleg element and the rear leg element.

16. A method for positioning an article on a dog, the method comprising:
positioning the dog's front paws in a front leg element having a front left pouch, a front right pouch, and a shoulder element, wherein the positioning includes:
positioning the dog's front left paw in the front left pouch;
positioning the dog's front right paw in the front right pouch; and
wrapping the shoulder element over the dog's shoulders,
wherein the front leg element is positioned to transmit a first force tending to pull the front left pouch away from the front left paw to pull the front right pouch toward the front right paw; and
positioning the dog's rear paws in a rear leg element having a rear left pouch, a rear right pouch, and a back element, wherein the positioning includes:
positioning the dog's rear left paw in the rear left pouch;
positioning the dog's rear right paw in the rear right pouch;
wrapping the back element over the dog's back,
wherein the rear leg element is positioned to transmit a second force tending to pull the rear left pouch away from the rear left paw to pull the rear right pouch toward the rear right paw; and
positioning a connecting element on the dog's back to extend between the front leg element and the rear leg element, wherein the connecting element is positioned to transmit a third force tending to pull the rear leg element backwards to pull the front leg element backwards.

17. The method of claim 16 wherein the front leg element is further positioned so the dog's front right paw restricts the movement of the front left pouch by resisting the pull of the first force further toward the front right paw.

18. The method of claim 16 wherein the rear leg element is further positioned so the dog's rear right paw restricts the movement of the rear left pouch by resisting the pull of the second force further toward the rear right paw.

19. The method of claim 16 wherein the front leg element is further positioned to transmit the third force transmitted to pull the front leg element backwards is further transmitted to pull each of the front left and right pouches upwards.

20. The method of claim 16 wherein the rear leg element is further positioned to transmit a third force tending to pull the front leg element forwards to each of the rear left and right pouches upwards.
